(19) United States
(12) Patent Application Publication
(10) Pub. No.: US 2026/0157925 A1
(43) Pub. Date: Jun. 11, 2026

(54) MASSAGE CORE MECHANISM

(71) Applicant: XIAMEN COMFIER TECHNOLOGY CO., LTD., Fujian (CN)

(72) Inventors: Jianqing LI, Fujian (CN); Zhicheng ZHANG, Fujian (CN)

(21) Appl. No.: 19/383,654

(22) Filed: Nov. 8, 2025

(30) Foreign Application Priority Data
Dec. 6, 2024 (CN) 2024230065875

(51) Int. Cl. A61H 23/00; A61H 7/00; A61H 23/02

(52) U.S. Cl. CPC A61H 23/006; A61H 7/007; A61H 23/0254; A61H 2201/149

(57) ABSTRACT

A massage core mechanism, including a travelling mechanism mounted on a housing to drive the housing to move on a back shell, two massage assemblies, a kneading mechanism that drives the two massage assemblies to move to perform kneading massage, and a tapping mechanism that drives two respective ends of the two massage assemblies to move up and down alternately to perform tapping massage. The massage core mechanism has a simpler and more compact structure.

### TECHNICAL FIELD

The present invention relates to the technical field of massage apparatus, and more specifically to a massage core mechanism.

### BACKGROUND OF THE INVENTION

With the continuous improvement of people's living standards and the increasing awareness of health, various medical and health care devices have become increasingly popular, especially the demand for massage apparatus. A massage core mechanism is a key component of a massage apparatus, primarily used to implement functions such as kneading and tapping on the body.

An existing massage core mechanism generally includes massage heads and their driving mechanisms. Through different driving mechanisms, the massage heads can perform various actions, thereby enabling a single massage core mechanism to perform different functions such as kneading and tapping. However, in the existing massage core mechanism, multiple driving mechanisms typically share a single motor. The motor transmits motion forces of different forms to the massage heads through different motion transmission components, thereby enabling the massage heads to perform different actions.

In the aforementioned structure, the different motion transmission components share a single power source, but they must not interfere with one another. As a result, the overall motion transmission structure becomes complex and lacks compactness. This results in a large spatial footprint, making the entire massage core mechanism bulky, which is inconvenient for transportation and storage. Furthermore, the complicated motion transmission structure requires higher research and development costs and more parts to be used, especially the use of non-standard parts. This increases the difficulty of producing and assembling the massage core mechanism, which does not facilitate industrialized mass production, and indirectly increases the price of the massage apparatus (such as a massage cushion or massage chair). In addition, it may be difficult to control independently the different forces transmitted to the massage heads by the different motion transmission components, leading to imprecise force transmission to the massage heads or a tendency for vibrations of the massage heads, resulting in poor stability and a negative user's experience.

### BRIEF SUMMARY OF THE INVENTION

An object of the present invention is to provide a massage core mechanism with a simpler and more compact motion transmission structure and precise force application.

To achieve the above object, the present invention provides the following technical solutions:

A massage core mechanism, comprising:
a mounting housing;
two massage assemblies mounted on the mounting housing;
a tapping mechanism, configured to drive two respective ends of the two massage assemblies to move up and down alternately to imitate tapping motion; the tapping mechanism comprises a first motor and a first transmission assembly; the first transmission assembly is connected to and driven by the first motor, and the first transmission assembly is connected to the two massage assemblies; the first transmission assembly comprises a belt and pulley assembly, a first transmission shaft, two tapping eccentric wheels, and two tapping transmission rods; the first transmission shaft is connected to and driven by the first motor via the belt and pulley assembly; the two tapping eccentric wheels are arranged on two ends of the first transmission shaft respectively, and a front end of each of the two tapping eccentric wheels is fixedly connected to one end of a corresponding one of the two tapping transmission rods; another end which is a free end of each of the two tapping transmission rods is connected to and abuts against a corresponding one of the two massage assemblies;
a kneading mechanism, configured to drive the two massage assemblies to move to perform kneading massage; the kneading mechanism comprises a second motor and a second transmission assembly; the second transmission assembly is connected to and driven by the second motor, and the second transmission assembly is configured to drive the two massage assemblies to swing towards and away from each other repeatedly to imitate kneading motion;
a traveling mechanism, configured to drive the mounting housing to slide; the traveling mechanism comprises a third motor and a third transmission assembly; the third transmission assembly is connected to and driven by the third motor.

Further, an output shaft of the second motor is connected to a first worm; the second transmission assembly comprises a first worm gear, a first gear, a second transmission shaft, and two kneading eccentric wheels; the first worm gear meshes with the first worm; the first gear is fixed on the second transmission shaft and is connected to and driven by the first worm gear; the two kneading eccentric wheels are arranged on two ends of the second transmission shaft respectively; the two massage assemblies are assembled onto the two kneading eccentric wheels respectively.

Further, each of the two massage assemblies comprises a massage arm and at least one massage head arranged on the massage arm; a middle part between two ends of the massage arm is connected to a socket portion extending downwardly from the massage arm; the socket portion sleeves a respective one of the two kneading eccentric wheels; a bottom side of the socket portion is connected to the free end of a respective one of the two tapping transmission rods.

Further, each of the two kneading eccentric wheels comprises a third eccentric wheel and a second eccentric wheel interconnected with each other; an eccentric connecting sleeve is formed between a junction which the third eccentric wheel and the second eccentric wheel are connected, and the eccentric connecting sleeve is inclined with respective to a perpendicular orientation with respect to the second transmission shaft; the eccentric connecting sleeve is sleeved by a respective socket portion.

Further, the socket portion comprises two opposing plate bodies; a through-hole is provided on the socket portion; a bearing is provided on the eccentric connecting sleeve to connect with an inner wall of the through-hole of the respective socket portion.

Further, each of the two massage assemblies is also connected to a tension spring; an upper end of the tension spring is connected to a front end of the massage arm, and a lower end of the tension spring is connected to the socket portion; when performing a tapping massage action, the two ends of the massage arms are raised with respect to the socket portion.

Further, a ball head is formed on the free end of each of the two tapping transmission rods, and a spherical cavity into which the ball head is inserted and retained is formed at a bottom side of the socket portion.

Further, the third transmission assembly comprises a third worm gear, a third transmission gear assembly, and a traveling gear; the third worm gear is connected to and driven by the third motor; the traveling gear, the third transmission gear assembly, and the third worm gear mesh in sequence.

Further, the mounting housing comprises an upper housing and a lower housing detachably connected with each other; the two massage assemblies extend out of the upper housing; the traveling mechanism, the kneading mechanism, and the tapping mechanism are disposed between the upper housing and the lower housing.

Further, the kneading mechanism is located in a central part of the mounting housing, while the traveling mechanism and the tapping mechanism are located on two sides of the kneading mechanism respectively; the third transmission assembly and the first transmission assembly are located at one sides of the third motor and the first motor respectively.

According to the above technical solutions, the massage core mechanism of the present invention utilizes three motors to independently drive the traveling mechanism, the kneading mechanism, and the tapping mechanism respectively. Each mechanism is equipped with its own set of motion transmission components, which simplifies the structure of each motion transmission assembly and, in turn, simplifies the overall structure of the massage core mechanism. The three motors and the three mechanisms are arranged compactly within the massage core mechanism, reducing the overall volume of the massage core mechanism, which is convenient for transportation and storage, and further reduces research and development and material costs. In addition, when there are multiple driving mechanisms in the massage core mechanism, each driving mechanism can be independently controlled. The arrangement where each motor in each driving mechanism corresponds to one set of motion transmission components also makes force transmission more precise, allows for better control of the transmission force in each mechanism, and provides good operational stability.

### BRIEF DESCRIPTION OF THE DRAWINGS

FIG. 1 is a perspective view of the present invention.

FIG. 2 is a perspective view of the present invention with the upper housing omitted.

FIG. 3 is a top view of FIG. 2.

FIG. 4 is a perspective view of the present invention in another angle, with the upper housing omitted.

FIG. 5 is an exploded schematic view of the present invention.

FIG. 6 is an assembled schematic view of the kneading mechanism.

FIG. 7 is an exploded schematic view of the kneading mechanism.

FIG. 8 is an assembled schematic view of the tapping mechanism.

FIG. 9 is an assembled schematic view of the traveling mechanism.

### REFERENCE NUMERALS

1 Mounting housing
11 Upper housing
12 Lower housing
121 Guide groove
2 Massage assembly
21 Massage arm
22 Massage head
23 Socket portion
231 Through-hole
232 Plate body
233 Spherical cavity
3 Traveling mechanism
31 Third motor
311 Third worm
A Third transmission assembly
32 Third worm gear
33 Third transmission gear assembly
34 Traveling gear
4 Kneading mechanism
41 Second motor
B Second transmission assembly
411 First worm
42 First worm gear
43 First gear
44 Second transmission shaft
45 Kneading eccentric wheel set
451 Third eccentric wheel
452 Second eccentric wheel
453 Bearing
46 Eccentric connecting sleeve
5 Tapping mechanism
51 First motor
C First transmission assembly
52 Tension spring
53 Belt and pulley assembly
54 First transmission shaft
55 Tapping eccentric wheel
56 Tapping transmission rod
561 Ball head

### DETAILED DESCRIPTION OF THE INVENTION

To further explain the technical solutions of the present invention, the present invention will now be described in detail through specific embodiments.

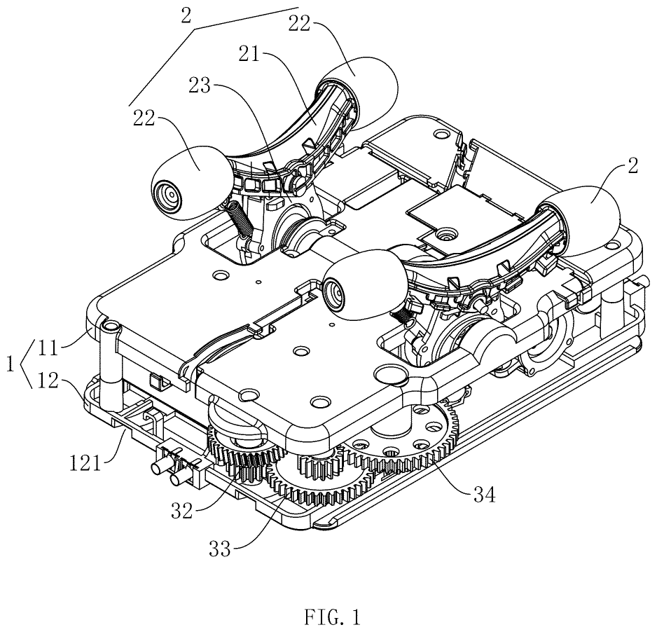

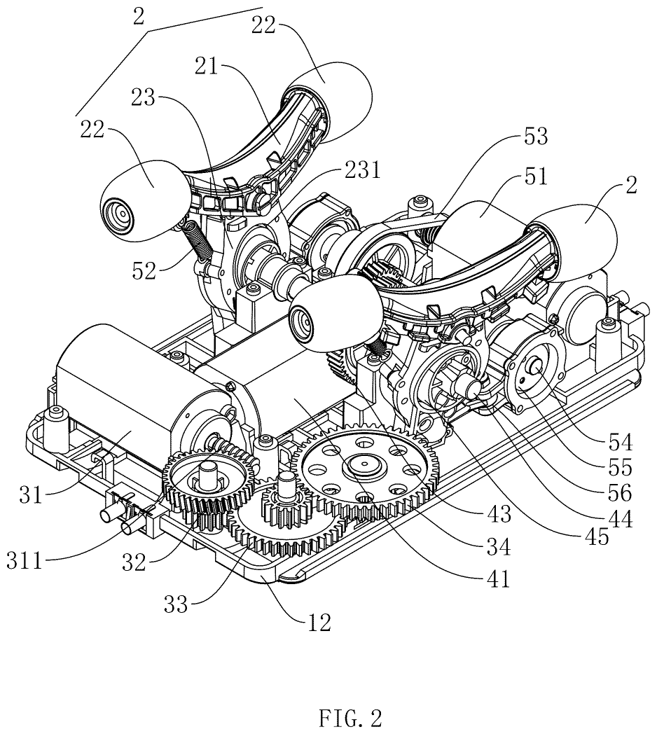

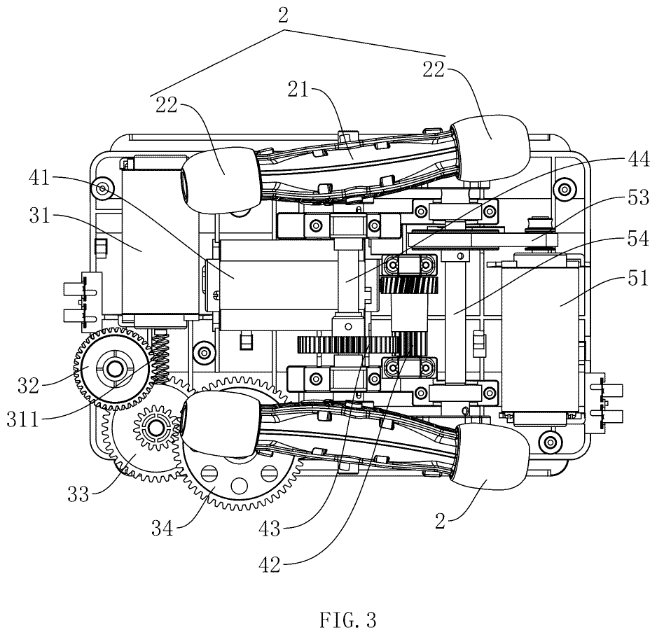

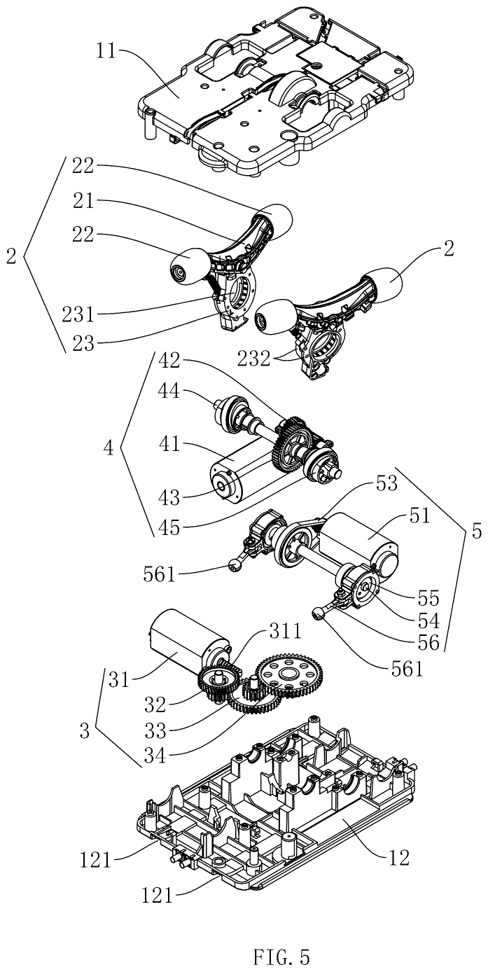

With reference to FIG. 1 through FIG. 5, the present invention discloses a massage core mechanism. The massage core mechanism can be slidably arranged on a back shell (not shown in the figures). The back shell can be a backplate of a massage cushion, massage chair, or massage bed. The massage core mechanism comprises:
a mounting housing 1; a tapping mechanism 5, two massage assemblies 2, a kneading mechanism 4, and a traveling mechanism 3 are arranged on the mounting housing 1;
wherein the tapping mechanism 5 is configured to drive two respective ends of the two massage assemblies 2 to move up and down alternately to imitate tapping motion, and the tapping mechanism 5 comprises a first motor 51 and a first transmission assembly C. The first transmission assembly C is connected to and driven by the first motor 51, and the first transmission assembly C is connected to the two massage assemblies 2;

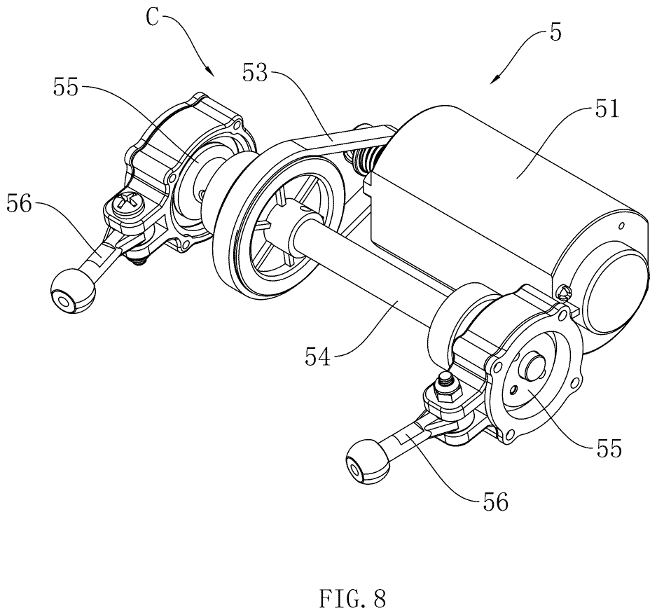

Further with reference to FIG. 8, the first transmission assembly C comprises a belt and pulley assembly 53, a first transmission shaft 54, two tapping eccentric wheels 55, and two tapping transmission rods 56. The first transmission shaft 54 is connected to and driven by the first motor 51 via the belt and pulley assembly 53. The two tapping eccentric wheels 55 are arranged on two ends of the first transmission shaft 54 respectively, and a front end of each of the two tapping eccentric wheels 55 is fixedly connected to one end of a corresponding one of the two tapping transmission rods 56. Another end, i.e., a free end, of each of the two tapping transmission rods 56 is connected to and abuts against a corresponding one of the two massage assemblies 2.

The kneading mechanism 4 is configured to drive the two massage assemblies 2 to move to perform kneading massage, and the kneading mechanism 4 comprises a second motor 41 and a second transmission assembly B. The second transmission assembly B is connected to and driven by the second motor 41, and the second transmission assembly B can drive the two massage assemblies 2 to swing towards and away from each other repeatedly to imitate kneading motion.

The traveling mechanism 3 is configured to drive the mounting housing 1 to slide (on the back shell), and the traveling mechanism 3 comprises a third motor 31 and a third transmission assembly A. The third transmission assembly A is connected to and driven by the third motor 31.

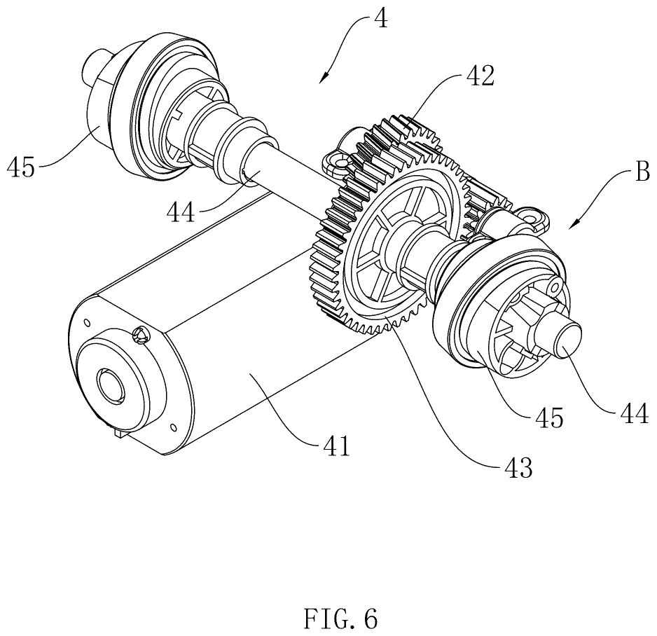

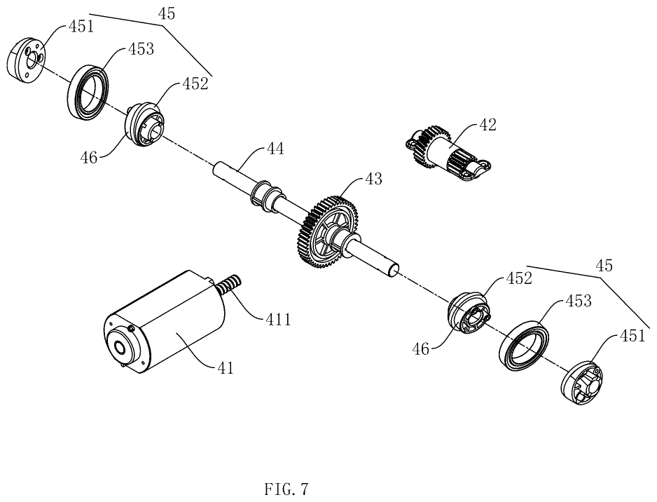

With reference to FIG. 6 and FIG. 7, an output shaft of the second motor 41 is connected to a first worm 411. In this embodiment, an output shaft of the second motor 41 is the first worm 411. The second transmission assembly B comprises a first worm gear 42, a first gear 43, a second transmission shaft 44, and two kneading eccentric wheels 45. The first worm gear 42 meshes with the first worm 411 and is thus connected to and driven by the second motor 41. The first gear 43 is fixed on the second transmission shaft 44 and is connected to and driven by the first worm gear 42. The two kneading eccentric wheels 45 are arranged on two ends of the second transmission shaft 44 respectively. The two kneading eccentric wheels 45 are connected to the two massage assemblies 2 respectively and drive the two massage assemblies 2 to move, and the two massage assemblies 2 are assembled onto the two kneading eccentric wheels 45 respectively.

Each of the two massage assemblies 2 comprises a massage arm 21 and at least one massage head 22 arranged on the massage arm 21. In this embodiment, said at least one massage head 22 comprises two massage heads 22 arranged on two ends of the massage arm 21 which is laterally oriented. A middle part between two ends of the massage arm 21 is connected to a socket portion 23 extending downwardly from the massage arm 21; the socket portion 23 can sleeve a respective one of the two kneading eccentric wheels 45. A bottom side of the socket portion 23 is connected to the free end of a respective one of the two tapping transmission rods 56. The two ends of massage arm 21 can be slightly curved upwards with respect to the middle part between the two ends of the massage arm 21.

Each of the two kneading eccentric wheels 45 comprises a third eccentric wheel 451 and a second eccentric wheel 452 interconnected with each other. An eccentric connecting sleeve 46 is formed between a junction which the third eccentric wheel 451 and the second eccentric wheel 452 are connected, and the eccentric connecting sleeve 46 is inclined with respective to a perpendicular orientation with the second transmission shaft 44. The eccentric connecting sleeve 46 is sleeved by a respective socket portion 23. Specifically, the socket portion 23 comprises two opposing plate bodies 232. A through-hole 231 for sleeving a respective one of the two kneading eccentric wheels 45 is provided on the socket portion 23. A bearing 453 is provided on the eccentric connecting sleeve 46 to connect with an inner wall of the through-hole 231 of the respective socket portion 23, so that the respective socket portion 23 is connected to and driven by the eccentric connecting sleeve 46, thereby allowing the two kneading eccentric wheels 45 to rotate more smoothly.

When the kneading mechanism 4 is powered on, the second motor 41 operates, thereby transmitting power sequentially through the first worm 411 to the first worm gear 42, the first gear 43, and the second transmission shaft 44. As a result, the two kneading eccentric wheels 45 located at the two ends of the second transmission shaft 44 rotate. The eccentric connecting sleeve 46 on each of the two kneading eccentric wheels 45, oriented at an inclined angle with respect to a perpendicular orientation of the second transmission shaft 44, can drive the massage arm 21 of a corresponding one of the two massage assemblies 2 to perform kneading motion via the socket portion 23 connected to the eccentric connecting sleeves 46. Therefore, as the two kneading eccentric wheels 45 rotate, they can drive the massage arms 21 of the two massage assemblies 2 to swing repeatedly towards and away from each other to imitate kneading motion.

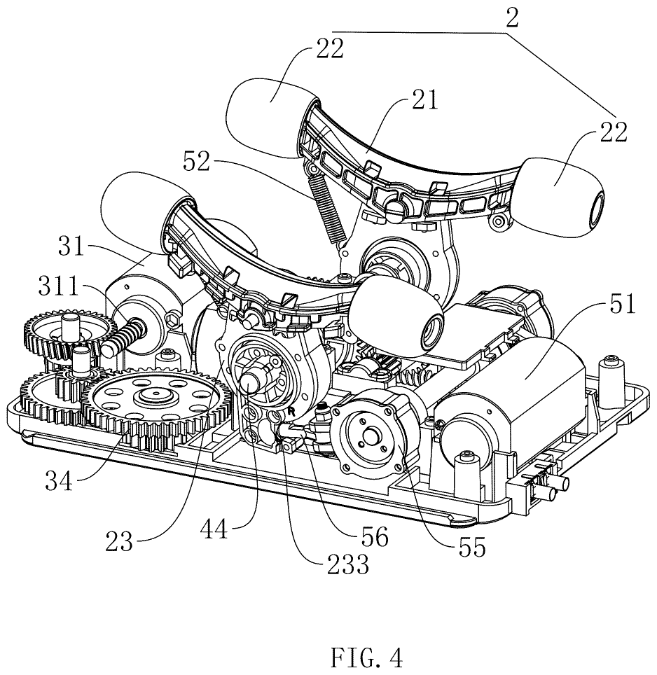

Preferably, each of the two massage assemblies 2 can also be connected to an elastic reset member. In this embodiment, the elastic reset member is a tension spring 52. An upper end of the tension spring 52 is connected to a front end of the massage arm 21, and a lower end of the tension spring 52 is connected to the socket portion 23. When performing a tapping massage action, the elastic reset member can assist said at least one massage head 22 moved upwards to return to an original position and can also buffer the tapping motion. Since the tapping mechanism 5 and the kneading mechanism 4 may operate simultaneously, a universal joint can be used for the connection between the free end of each of the two tapping transmission rods 56 and the respective socket portion 23. For example, a ball head 561 can be formed on the free end of each of the two tapping transmission rods 56, and a spherical cavity 233 (as indicated in FIG. 4) into which the ball head 561 can be inserted and retained can be formed at a bottom side of the socket portion 23. The spherical cavity 233 can be located between the two opposing plate bodies 232. Two ends of each of the two tapping transmission rods 56 can be disposed with a certain height difference to better drive the massage heads 22 at the two ends of the massage arm 21 to tilt up and down to perform tapping motion. When the socket portion 23 is performing a kneading motion with the kneading mechanism 4, an angle between a respective tapping transmission rod 56 and the socket portion 23 changes continuously, but the respective tapping transmission rod 56 can still transmit force to a corresponding massage assembly 2, causing the massage arm 21 to perform a tapping motion.

When the tapping mechanism 5 is powered on, the first motor 51 drives the first transmission shaft 54 to rotate via the belt and pulley assembly 53 such that the two tapping eccentric wheels 55 located at the two ends of the first transmission shaft 54 are driven to rotate, causing the two tapping transmission rods 56 connected to the two tapping eccentric wheels 55 to be displaced towards a front-back direction, and because of the eccentricity of the two tapping eccentric wheels 55, the socket portion 23 at the bottom side of each of the two massage assemblies 2 is pushed by a respective one of the two tapping transmission rods 56. This causes the massage arm 21 above the socket portion 23 to reciprocate towards a front-back direction and perform up-and-down tapping motion simultaneously (a seesaw-like action where the two ends of the massage arm 21 go high and low alternately). In addition, an elastic force provided by the tension spring 52 also serves to assist in applying force, ensuring that each massage head 22 has sufficient tapping force and also creating a buffering effect for each massage head 22.

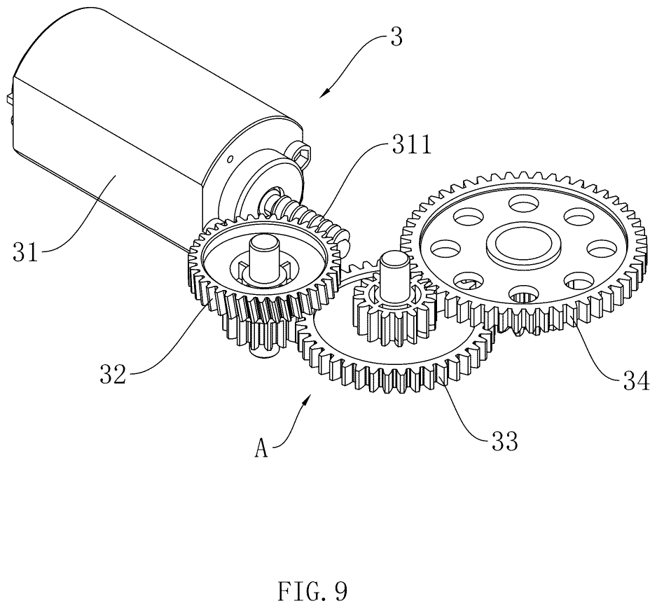

With reference to FIG. 9, the third transmission assembly A comprises a third worm gear 32, a third transmission gear assembly 33, and a traveling gear 34. The third worm gear 32 is connected to and driven by the third motor 31. The traveling gear 34, the third transmission gear assembly 33, and the third worm gear 32 mesh in sequence. A rack that meshes with the traveling gear 34 is provided on the back shell. An output shaft of the third motor 31 is connected to a third worm 311 to drive the third worm 311. In this embodiment, the output shaft of the third motor 31 is the third worm 311, and the third worm gear 32 meshes with the third worm 311 so as to be driven by the third motor 31.

As shown in FIG. 1 to FIG. 5, the mounting housing 1 of this embodiment comprises an upper housing 11 and lower housing 12 detachably connected with each other. The two massage assemblies 2 extend out of the upper housing 11. The traveling mechanism 3, the kneading mechanism 4, and the tapping mechanism 5 are disposed between the upper housing 11 and the lower housing 12. By this arrangement, the kneading mechanism 4 and the tapping mechanism 5 drive the two massage assemblies 2 to move within the mounting housing 1, causing the massage arms 21 and said at least one massage head 22 that extend out of the upper housing 11 to perform kneading and tapping motions. Further, the traveling gear 34 of the traveling mechanism 3 meshes with the rack on the back shell to enable the entire massage core mechanism to slide and travel on the back shell. A back of the lower housing 12 has guide grooves 121. Guide rails (not shown in the figures) are provided on the back shell. When the massage core mechanism travels on the back shell, the guide rails are embedded in the guide grooves 121, preventing the massage core mechanism from deviation during travelling. In the mounting housing 1, because three motors independently drive the traveling mechanism 3, the kneading mechanism 4, and the tapping mechanism 5 respectively, each mechanism can work independently or simultaneously. Each mechanism is equipped with a set of motion transmission components, which simplifies the structure of each motion transmission assembly, eliminating the need to design or equip complex motion transmission mechanisms, thereby resulting in high reliability and good operational stability.

Additionally, in this embodiment, within the mounting housing 1, the kneading mechanism 4 is located in a central part of the mounting housing 1, while the traveling mechanism 3 and the tapping mechanism 5 are located on two sides of the kneading mechanism 4 respectively. The third transmission assembly A and the first transmission assembly C are located at one sides of the third motor 31 and the first motor 51 respectively, and their structures being arranged in an inner space of the mounting housing 1 to be compactly arranged therein. This makes good and reasonable use of the space and the overall structural layout, making the structure more compact and reducing the overall volume of the massage core mechanism.

The foregoing is merely one embodiment of the present invention and is not intended to limit the present invention. Any modifications, equivalent substitutions, and improvements made within the spirit and principles of the present invention shall be included within the protection scope of the present invention.

1. A massage core mechanism, comprising:
a mounting housing;
two massage assemblies mounted on the mounting housing;
a tapping mechanism, configured to drive two respective ends of the two massage assemblies to move up and down alternately to imitate tapping motion;
the tapping mechanism comprises a first motor and a first transmission assembly; the first transmission assembly is connected to and driven by the first motor, and the first transmission assembly is connected to the two massage assemblies; the first transmission assembly comprises a belt and pulley assembly, a first transmission shaft, two tapping eccentric wheels, and two tapping transmission rods; the first transmission shaft is connected to and driven by the first motor via the belt and pulley assembly; the two tapping eccentric wheels are arranged on two ends of the first transmission shaft respectively, and a front end of each of the two tapping eccentric wheels is fixedly connected to one end of a corresponding one of the two tapping transmission rods; another end which is a free end of each of the two tapping transmission rods is connected to and abuts against a corresponding one of the two massage assemblies;
a kneading mechanism, configured to drive the two massage assemblies to move to perform kneading massage; the kneading mechanism comprises a second motor and a second transmission assembly; the second transmission assembly is connected to and driven by the second motor, and the second transmission assembly is configured to drive the two massage assemblies to swing towards and away from each other repeatedly to imitate kneading motion;
a traveling mechanism, configured to drive the mounting housing to slide; the traveling mechanism comprises a third motor and a third transmission assembly; the third transmission assembly is connected to and driven by the third motor.

2. The massage core mechanism of claim 1, wherein an output shaft of the second motor is connected to a first worm; the second transmission assembly comprises a first worm gear, a first gear, a second transmission shaft, and two kneading eccentric wheels; the first gear is fixed on the second transmission shaft and is connected to and driven by the first worm gear; the two kneading eccentric wheels are arranged on two ends of the second transmission shaft respectively; the two massage assemblies are assembled onto the two kneading eccentric wheels respectively.

3. The massage core mechanism of claim 2, wherein each of the two massage assemblies comprises a massage arm and at least one massage head arranged on the massage arm; a middle part between two ends of the massage arm is connected to a socket portion extending downwardly from the massage arm; the socket portion sleeves a respective one of the two kneading eccentric wheels; a bottom side of the socket portion is connected to the free end of a respective one of the two tapping transmission rods.

4. The massage core mechanism of claim 3, wherein each of the two kneading eccentric wheels comprises a third eccentric wheel and a second eccentric wheel interconnected with each other; an eccentric connecting sleeve is formed between a junction which the third eccentric wheel and the second eccentric wheel are connected, and the eccentric connecting sleeve is inclined with respective to a perpendicular orientation with respect to the second transmission shaft; the eccentric connecting sleeve is sleeved by a respective socket portion.

5. The massage core mechanism of claim 4, wherein the socket portion comprises two opposing plate bodies; a through-hole is provided on the socket portion; a bearing is provided on the eccentric connecting sleeve to connect with an inner wall of the through-hole of the respective socket portion.

6. The massage core mechanism of claim 3, wherein each of the two massage assemblies is also connected to a tension spring; an upper end of the tension spring is connected to a front end of the massage arm, and a lower end of the tension spring is connected to the socket portion; when performing a tapping massage action, the two ends of the massage arms are raised with respect to the socket portion.

7. The massage core mechanism of claim 6, wherein a ball head is formed on the free end of each of the two tapping transmission rods, and a spherical cavity into which the ball head is inserted and retained is formed at a bottom side of the socket portion.

8. The massage core mechanism of claim 1, wherein the third transmission assembly comprises a third worm gear, a third transmission gear assembly, and a traveling gear; the third worm gear is connected to and driven by the third motor; the traveling gear, the third transmission gear assembly, and the third worm gear mesh in sequence.

9. The massage core mechanism of claim 1, wherein the mounting housing comprises an upper housing and a lower housing detachably connected with each other; the two massage assemblies extend out of the upper housing; the traveling mechanism, the kneading mechanism, and the tapping mechanism are disposed between the upper housing and the lower housing.

10. The massage core mechanism of claim 1, wherein the kneading mechanism is located in a central part of the mounting housing, while the traveling mechanism and the tapping mechanism are located on two sides of the kneading mechanism respectively; the third transmission assembly and the first transmission assembly are located at one sides of the third motor and the first motor respectively.
